(19) United States
(12) Patent Application Publication
(10) Pub. No.: US 2019/0376818 A1
(43) Pub. Date: Dec. 12, 2019

(54) ENCODER

(71) Applicant: FANUC CORPORATION, Yamanashi (JP)

(72) Inventors: Masao FUKUDA, Yamanashi-ken (JP); Nobuyuki OOTAKE, Yamanashi-ken (JP)

(21) Appl. No.: 16/430,510

(22) Filed: Jun. 4, 2019

(30) Foreign Application Priority Data
Jun. 6, 2018 (JP) 2018-108355

(51) Int. Cl. G01D 5/347

(52) U.S. Cl. CPC G01D 5/34723; G01D 5/34776

(57) ABSTRACT

An encoder includes: a disk having a pattern of slits arranged in one direction; a light emitting element for emitting light toward the pattern of the disk; a plurality of light receiving elements arranged in the direction in which the slits are arranged and configured to receive the light emitted from the light emitting element, by way of the slits; and an optical element configured to magnify an image formed by the light which is emitted by the light emitting element and then reaches the optical element by way of the slits and to transmit the magnified image toward the light receiving elements, the optical element having a magnification ratio that is set so as to magnify the formed image at least in the direction in which the light receiving elements are arranged, depending on the pitch of the slits and the pitch of the light receiving elements.

### CROSS-REFERENCE TO RELATED APPLICATION

This application is based upon and claims the benefit of priority from Japanese Patent Application No. 2018-108355 filed on Jun. 6, 2018, the contents of which are incorporated herein by reference.

### BACKGROUND OF THE INVENTION

### Field of the Invention

The present invention relates to an optical encoder.

### Description of the Related Art

Japanese Laid-Open Patent Publication No. 2015-090306 discloses an optical encoder having a plurality of light receiving elements for receiving light reflected by slits provided on a disk at a predetermined pitch.

### SUMMARY OF THE INVENTION

In the encoder of the technology disclosed in Japanese Laid-Open Patent Publication No. 2015-090306, the resolution can be increased as the pitch of the slits is narrowed and as the pitch of the light receiving elements is narrowed corresponding to the pitch of the slits. However, in manufacturing of the light receiving elements, the pitch of the light receiving elements needs to be set at a certain distance or greater, which has been a factor of hindering the improvement of resolution.

The present invention has been devised to solve the above problems, and therefore an object of the present invention is to provide an encoder capable of improving resolution.

According to an aspect of the present invention, an encoder includes: a disk configured to have a pattern of slits arranged in one direction; a light emitting element configured to emit light toward the pattern of the disk; a plurality of light receiving elements arranged in the direction in which the slits are arranged and configured to receive the light emitted from the light emitting element, by way of the slits; and an optical element configured to magnify an image formed by the light which is emitted by the light emitting element and then reaches the optical element by way of the slits and to transmit the magnified image toward the light receiving elements, the optical element having a magnification ratio that is set so as to magnify the formed image at least in the direction in which the multiple light receiving elements are arranged, depending on the pitch of the slits and the pitch of the light receiving elements.

According to the present invention, it is possible to improve the resolution of the encoder.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic view of an encoder;

FIG. 2 is a schematic view of a disk as viewed from the rotational axis direction;

FIG. 3 is an enlarged schematic view of a pattern of a disk;

FIG. 4 is a schematic view of an optical unit;

FIG. 5 is a schematic view for explaining magnifying of the image by a fiber optic plate;

FIG. 6 is a schematic view of light receiving elements;

FIG. 7 is a schematic view of an encoder; and

FIG. 8 is a schematic view of an encoder.

### DESCRIPTION OF THE PREFERRED EMBODIMENTS

### First Embodiment

### [Overview of Encoder]

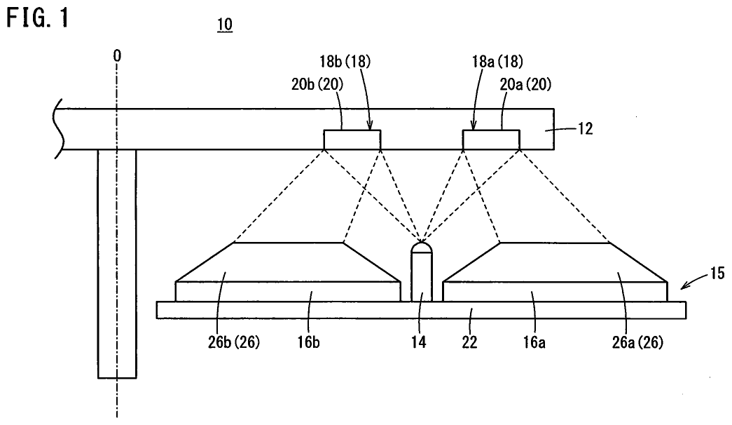

An encoder 10 of the present embodiment is an absolute type rotary encoder capable of detecting an absolute angle. FIG. 1 is a schematic view of the encoder 10. The encoder 10 includes a disk 12 that rotates integrally with a rotor such as a motor, and an optical unit 15 that emits light toward the disk 12 and receives reflected light from the disk 12.

### [Disk Configuration]

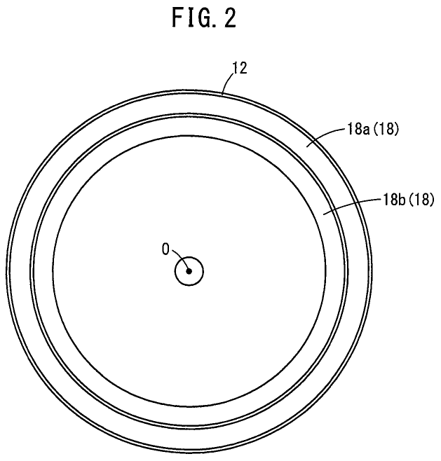

FIG. 2 is a schematic view of the disk 12 as viewed from the rotation axis 0 direction. The disk 12 is a circular plate having an incremental pattern 18a and an absolute pattern 18b provided on one surface thereof. The incremental pattern 18a and the absolute pattern 18b are provided concentrically around the entire circumference of the disk 12.

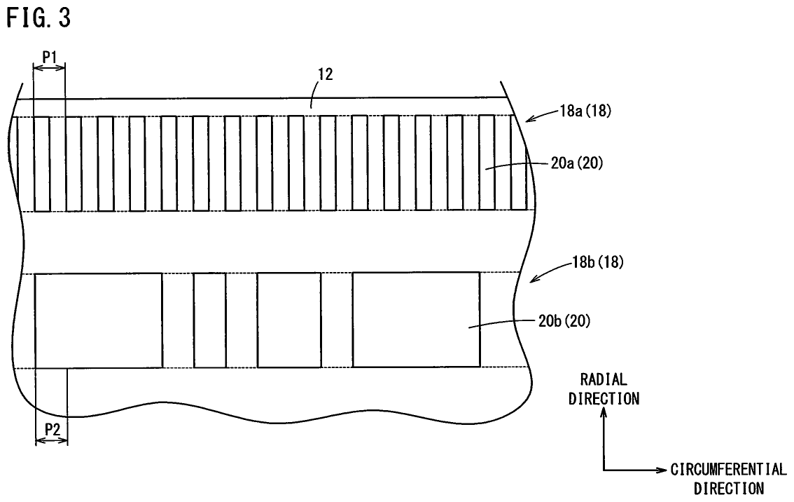

FIG. 3 is an enlarged schematic view of the incremental pattern 18a and the absolute pattern 18b on the disk 12. Although the incremental pattern 18a and the absolute pattern 18b are actually formed in a circular shape, they are schematically illustrated to be linear in FIG. 3. Hereinafter, when the incremental pattern 18a and the absolute pattern 18b do not need to be distinguished from one another, they may be collectively referred to as the pattern 18.

The incremental pattern 18a is composed of a plurality of slits 20a. The absolute pattern 18b is composed of a plurality of slits 20b. Hereinafter, when the slit 20a of the incremental pattern 18a and the slit 20b of the absolute pattern 18b do not need to be distinguished from each other, they may be collectively referred to as the slit 20.

The slit 20 is a reflective slit. The light emitted on the slit 20 of the surface of the disk 12 is reflected by the slit 20, but the light emitted on a place other than the slits 20 is absorbed. The disk 12 is made of, for example, a material that reflects light, such as metal, and the surface of the disk 12 excluding the portion of the slits 20 is coated with a material having a low reflectivity.

The plurality of slits 20a of the incremental pattern 18a are arranged at a predetermined pitch P1 in the circumferential direction of the disk 12. The multiple slits 20b of the absolute pattern 18b are formed to have different widths in an increment of a predetermined pitch P2 (i.e., unit width is the predetermined pitch P2), and are arranged in the circumferential direction of the disk 12. The width and position of each slit 20b of the absolute pattern 18b are so set that the pattern of output signals from the aftermentioned nine light receiving elements 240 to 248 as a result of reception of the reflected light from the slits 20b is uniquely defined by a rotational position of the disk 12 within one revolution.

### [Configuration of Optical Unit]

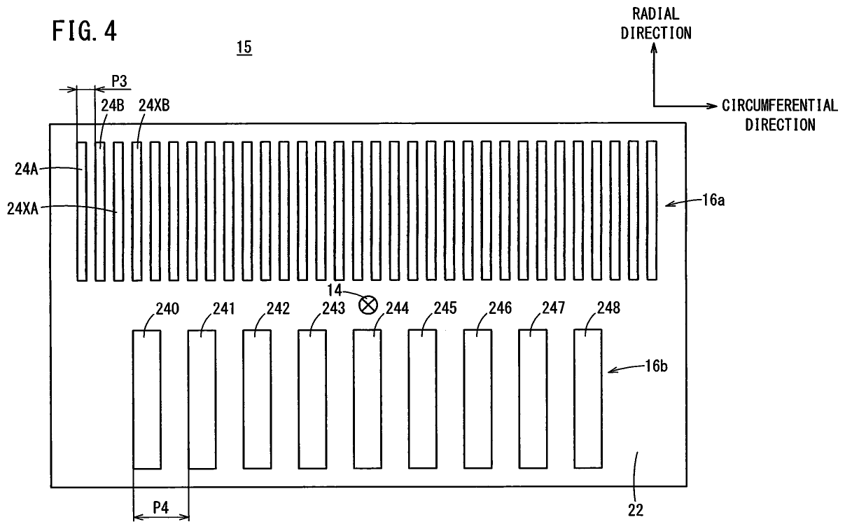

FIG. 4 is a schematic view of the optical unit 15. The optical unit 15 includes a light emitting element 14 for emitting light toward the disk 12, an incremental light receiver 16a for receiving reflected light from the slits 20a of the incremental pattern 18a, and an absolute light receiver 16b for receiving reflected light from the slits 20b of the absolute pattern 18b. The incremental light receiver 16a and the absolute light receiver 16b are provided in arc shapes, but are schematically illustrated in linear shapes in FIG. 4.

The light emitting element 14 is formed of, for example, an LED, and illuminates both the incremental pattern 18a and the absolute pattern 18b on the disk 12. The light emitting element 14 is provided on a substrate 22. The incremental light receiver 16a is disposed radially outward with respect to the light emitting element 14, and the absolute light receiver 16b is disposed radially inward with respect to the light emitting element 14.

The incremental light receiver 16a includes light receiving elements 24A, 24B, 24XA, 24XB provided on the substrate 22, and the four light receiving elements 24A, 24B, 24XA, 24XB form one set of light receiving elements. The incremental light receiver 16a is configured of multiple sets of light receiving elements (eight sets in the present embodiment). The absolute light receiver 16b is composed of multiple (nine in the present embodiment) light receiving elements 240 to 248 provided on the substrate 22. The light receiving elements 24A, 24B, 24XA, 24XB as well as the light receiving elements 240 to 248 are photodiodes, and output signals according to the amount of light received. Hereinafter, when the light receiving elements 24A, 24B, 24XA, 24XB and the light receiving elements 240 to 248 are not particularly distinguished, they may be collectively referred to as the light receiving element 24.

The light receiving elements 24A, 24B, 24XA, 24XB are arranged in a direction in which the slits 20a of the incremental pattern 18a are arranged. The light receiving elements 24A, 24B, 24XA, 24XB are provided on the substrate 22 at a predetermined pitch P3.

The light receiving elements 24A, 24B, 24XA and 24XB output sinusoidal signals as the rotation angle of the disk 12 changes. The light receiving element 24B outputs a signal having a phase delay of π/2 [rad] in electrical angle relative to the signal output from the light receiving element 24A. The light receiving element 24XA outputs a signal having a phase delay of π [rad] in electrical angle relative to the signal output from the light receiving element 24A. The light receiving element 24XB outputs a signal having a phase delay of π [rad] in electrical angle relative to the signal output from the light receiving element 24B.

The light receiving elements 240 to 248 are arranged in a direction in which the slits 20b of the absolute pattern 18b are arranged. The light receiving elements 240 to 248 are provided on the substrate 22 at a predetermined pitch P4.

The light receiving elements 240 to 248 output rectangular wave signals as the rotational angle of the disk 12 changes. The rotational position of the disk 12 within one revolution can be determined based on the combination of the signals output from the light receiving elements 240 to 248.

### [Configuration of Fiber Optic Plate (FOP)]

As shown in FIG. 1, a fiber optic plate 26a (hereinafter referred to as “FOP 26a”) is provided on a surface of the incremental light receiver 16a that faces the disk 12. A fiber optic plate 26b (hereinafter referred to as FOP 26b) is similarly provided on a surface of the absolute light receiver 16b that faces the disk 12. Hereinafter, when the FOP 26a and the FOP 26b are not particularly distinguished from one another, they are collectively referred to as the FOP 26. The FOP 26 constitutes an optical element.

The FOP 26 is formed by bundling optical fibers. The FOP 26 is formed, by heat-treatment, into a tapered shape so that the area progressively increases from one surface to the opposite surface. As a result, the FOP 26 can magnify an image incident on the one surface and output the magnified image through the opposite surface.

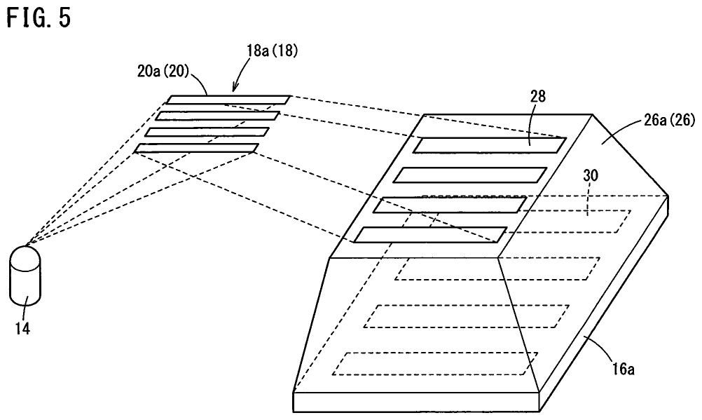

FIG. 5 is a schematic view for explaining magnifying of the image by the FOP 26a. The light emitted from the light emitting element 14 toward the incremental pattern 18a is reflected by the slits 20a. The reflected lights from the slits 20a form images on the surface of the FOP 26a facing the disk 12. The image (reflected image 28) formed on the surface of the FOP 26a facing the disk 12 is magnified by the FOP 26a and output from the surface of FOP 26a facing the incremental light receiver 16a, so that an image (magnified image 30) comes out on the incremental light receiver 16a.

The FOP 26a is configured such that the reflected image 28 will be magnified, as the magnified image 30, at least in the direction in which the light receiving elements 24A, 24B, 24XA, 24XB of the incremental light receiver 16a are arrayed. The magnification ratio of the image by the FOP 26a is set depending on the pitch P1 of the slits 20a of the incremental pattern 18a and the pitch P3 of the light receiving elements 24A, 24B, 24XA, 24XB.

Although, in the above, magnifying of the image by the FOP 26a provided on the incremental light receiver 16a has been described, the FOP 26b provided on the absolute light receiver 16b has a similar configuration. The magnification ratio of the image by the FOP 26b is set depending on the pitch P2 of the slits 20b of the absolute pattern 18b and the pitch P4 of the light receiving elements 240 to 248.

### [Operation and Effect]

In order to increase the resolution of the encoder 10, it is necessary to narrow the pitch P1 of the slits 20a of the incremental pattern 18a and the pitch P2 of the slits 20b of the absolute pattern 18b. When the pitch P1 of the slits 20a in the incremental pattern 18a and the pitch P2 of the slits 20b in the absolute pattern 18b are narrowed, the pitch P3 of the light receiving elements 24A, 24B, 24XA, 24XB in the incremental light receiver 16a and the pitch P4 of the light receiving elements 240 to 248 in the absolute light receiver 16b also need to be narrowed accordingly.

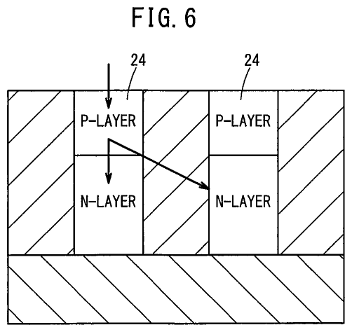

FIG. 6 is a schematic view of the light receiving element 24. As described above, the light receiving element 24 is a photodiode, which comprises a P-layer and an N-layer. When the light receiving element 24 receives light, holes move to the P-layer and free electrons move to the N-layer. If the pitch between the light receiving elements 24 is too narrow, free electrons may move to the N-layer of the adjacent light receiving elements 24, so that crosstalk may occur in which signals are output from the adjacent light receiving elements 24 that are not receiving light. In order to suppress the crosstalk, it is necessary to secure the pitch of the light receiving elements 24.

For this purpose, in the present embodiment, the FOP 26 is provided so as to magnify the image formed by the light that is emitted by the light emitting element 14 and then reflected from the slit 20 and to transmit the magnified image toward the light receiving element 24. Furthermore, based on the pitches P1 and P2 of the slits 20 and the pitches P3 and P4 of the light receiving elements 24, the magnification ratio of the FOP 26 is set so as to enlarge or magnify the image at least in the direction in which the multiple light receiving elements 24 are arrayed. As a result, even if the pitches P1 and P2 of the slits 20 are narrowed in order to enhance the resolution of the encoder 10, the pitches P3 and P4 of the light receiving elements 24 can be secured, whereby it is possible to suppress the occurrence of crosstalk.

### [Modification 1]

In the first embodiment, the FOP 26 is used to magnify the image formed by the reflected light from the slit 20 as a result of emission by the light emitting element 14 and then transmit the magnified image toward the light receiving element 24. However, instead of the FOP 26, a lens 32 may be used to magnify the image. Here, the lens 32 constitutes an optical element.

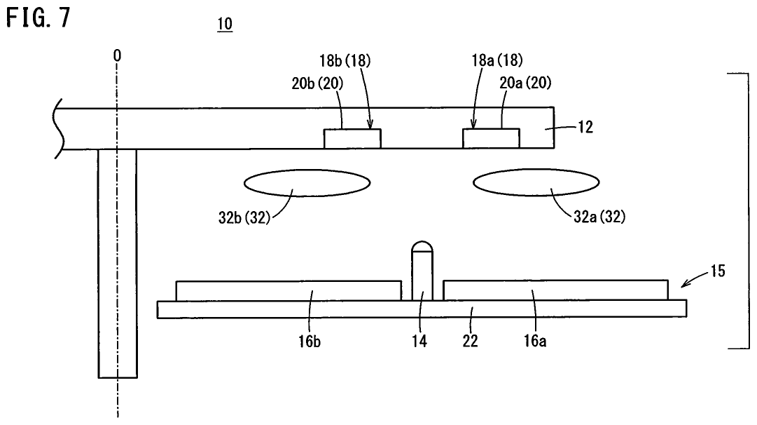

FIG. 7 is a schematic view of the encoder 10. As shown in FIG. 7, a lens 32a is provided on a side of the incremental light receiver 16a facing the disk 12. Another lens 32b is similarly provided on a side of the absolute light receiver 16b facing the disk 12.

The magnification ratio of the image by the lens 32a is set depending on the pitch P1 of the slits 20a of the incremental pattern 18a and the pitch P3 of the light receiving elements 24A, 24B, 24XA, 24XB. The magnification ratio of the image by the lens 32b is set depending on the pitch P2 of the slits 20b of the absolute pattern 18b and the pitch P4 of the light receiving elements 240 to 248.

### [Modification 2]

Though in the first embodiment, a reflective slit is used for the slit 20, a light-transmissive slit that transmits light may be used instead of the reflective slit.

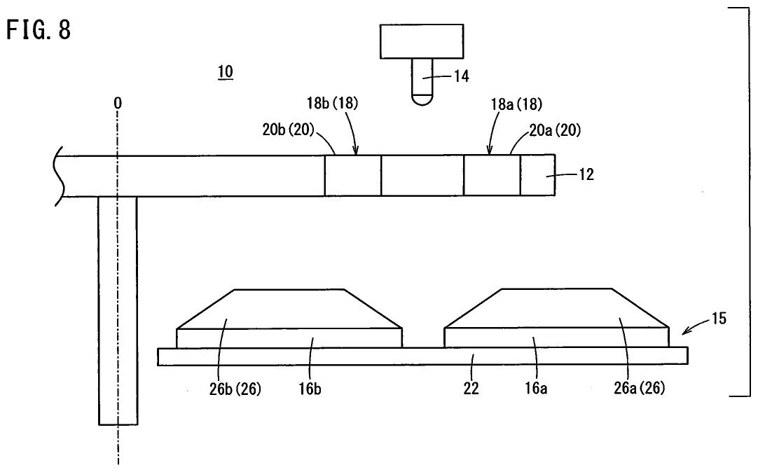

FIG. 8 is a schematic view of the encoder 10. As shown in FIG. 8, when a light-transmissive slit is used for the slit 20, the light emitting element 14 is arranged on the opposite side from the incremental light receiver 16a and the absolute light receiver 16b across the disk 12.

### [Modification 3]

The encoder 10 of the first embodiment is an absolute type rotary encoder, but the encoder 10 may be an increment type rotary encoder. In the case where the encoder 10 is an increment type rotary encoder, the absolute pattern 18b does not need to be provided on the disk 12, and the absolute light receiver 16b does not need to be provided either.

### [Modification 4]

Although the encoder 10 of the first embodiment is a rotary encoder, it may be a linear encoder.

### Technical Ideas Obtained from Embodiment

Technical ideas that can be grasped from the above embodiment will be described below.

The encoder (10) includes: a disk (12) configured to have a pattern (18) of slits (20) arranged in one direction; a light emitting element (14) configured to emit light toward the pattern of the disk; a plurality of light receiving elements (24) arranged in the direction in which the slits are arranged and configured to receive the light emitted from the light emitting element, by way of the slits; and an optical element (26) configured to magnify an image formed by the light which is emitted by the light emitting element and then reaches the optical element by way of the slits and to transmit the magnified image toward the light receiving elements, the optical element having a magnification ratio that is set so as to magnify the formed image at least in the direction in which the plurality of light receiving elements are arranged, depending on the pitch (P1) of the slits and the pitch (P3) of the light receiving elements. With the above configuration, even if the pitch of the slits is narrowed in order to enhance the resolution of the encoder, it is possible to secure the pitch of the light receiving elements and hence suppress the occurrence of crosstalk.

In the above encoder, the optical element may be a fiber optic plate (26). Thereby, it is possible to magnify the image formed by the light that is emitted from the light emitting element and then reaches the optical element by way of the slits.

In the above encoder, the optical element may be a lens (32). Thereby, it is possible to magnify the image formed by the light that is emitted from the light emitting element and then reaches the optical element by way of the slits.

In the above encoder, the pattern may include at least an incremental pattern (18a). Thereby, it is possible to improve the resolution of the encoder by narrowing the pitch of the incremental pattern.

In the above encoder, the pattern may include at least an absolute pattern (18b). Thereby, it is possible to improve the resolution of the encoder by narrowing the pitch of the absolute pattern.

In the above encoder, the slits may be reflective slits that reflect the light emitted from the light emitting element. Thereby, it is possible to improve the resolution of the encoder by narrowing the pitch of the reflective slits.

In the above encoder, the slits may be light-transmissive slits that transmit the light emitted from the light emitting element. Thereby, it is possible to improve the resolution of the encoder by narrowing the pitch of the light-transmissive slits.

While the invention has been particularly shown and described with reference to the preferred embodiments, it will be understood that variations and modifications can be effected thereto by those skilled in the art without departing from the scope of the invention as defined by the appended claims.

What is claimed is:

1. An encoder comprising:
a disk configured to have a pattern of slits arranged in one direction;
a light emitting element configured to emit light toward the pattern of the disk;
a plurality of light receiving elements arranged in the direction in which the slits are arranged and configured to receive the light emitted from the light emitting element, by way of the slits; and
an optical element configured to magnify an image formed by the light which is emitted by the light emitting element and then reaches the optical element by way of the slits and to transmit the magnified image toward the light receiving elements, the optical element having a magnification ratio that is set so as to magnify the formed image at least in the direction in which the plurality of light receiving elements are arranged, depending on a pitch of the slits and a pitch of the light receiving elements.

2. The encoder according to claim 1, wherein the optical element is a fiber optic plate.

3. The encoder according to claim 1, wherein the optical element is a lens.

4. The encoder according to claim 1, wherein the pattern includes at least an incremental pattern.

5. The encoder according to claim 1, wherein the pattern includes at least an absolute pattern.

6. The encoder according to claim 1, wherein the slits are reflective slits that reflect the light emitted from the light emitting element.

7. The encoder according to claim 1, wherein the slits are light-transmissive slits that transmit the light emitted from the light emitting element.
